(19) United States
(12) Patent Application Publication
(10) Pub. No.: US 2005/0195195 A1
(43) Pub. Date: Sep. 8, 2005

(54) System, apparatus and method of creating control paths for animated objects

(75) Inventors: Tom Brunet, Round Rock, TX (US); Barry Feigenbaum, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/793,466

(22) Filed: Mar. 4, 2004

(51) Int. Cl. G06T 13/00; G06T 15/70; G09G 5/02

(52) U.S. Cl. 345/473; 345/589

(57) ABSTRACT

A system, apparatus and method of creating a control path for an animated object are provided. The system, apparatus and method enable an animator to draw a control path over a background image. The background image is an image through which the animated object is to navigate. After drawing the control path over the background image, different colors may be assigned at different locations of the control path. Each color is used to instruct the animated object to take a specific action. For example, a color may be used to instruct the animated to move from right-to-left, another color may be used to instruct the object to stop, turn right, turn left etc. Consequently, as the animated object is moving along the control path and encounters a particular color, the animated object may behave as instructed.

### BACKGROUND OF THE INVENTION

1. Technical Field

The present invention is directed to computer animation. More specifically, the present invention is directed to a system, apparatus and method of creating control paths for computer animated objects.

2. Description of Related Art

In creating computer animation, an animator needs to design a path along which an animated object is to travel. The path may be designed by hand or by using any number of commercially available drawing programs or tablets. After creating the path, a program has to be generated to define the animated object's behavior along the path. For example, if the animated object is an individual moving through hallways of a building, the individual may :have to move through one hallway at a certain direction, through another hallway at a different direction and to take particular actions at certain hallway intersections. Thus, a program has to be created to properly control the motion of the individual.

Put differently, a path may be generated by mapping an object's position to a behavior at that position. The program may then iteratively determine the position of the animated object on the path, look up the behavior for the position of the object in the map, and perform the instructed action on the object. For all but the simplest of paths, creating such a mapping to control the behavior of an animated object along the path can be both excessively time consuming and error prone. (Note that a path with an accompanied program and mapping may be referred to as a control path.)

Thus, what is needed is a simplified system, apparatus and method of creating control paths for animated objects.

### SUMMARY OF THE INVENTION

The present invention provides a system, apparatus and method of creating a control path for an animated object. The system, apparatus and method enable an animator to draw a control path over a background image. The background image is an image through which the animated object is to navigate. After drawing the control path over the background image, different colors may be assigned at different locations of the control path. Each color is used to instruct the animated object to take a specific action. For example, a color may be used to instruct the animated to move from right-to-left, another color may be used to instruct the object to stop, turn right, turn left etc. Consequently, as the animated object is moving along the control path and encounters a particular color, the animated object may behave as instructed.

A plurality of animated objects may share the control path. In this case, a different group of colors (or color scheme) may be devised for each animated object. As the animated objects are traveling along the control path, the different color schemes may be consulted to determine which action each animated object is to take at any specific location.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a floor plan of a floor of a building.

FIG. 2 depicts a path along which an animated object may travel to evacuate the floor of the building.

FIG. 3 depicts FIG. 2 superimposed on FIG. 1.

FIG. 4 depicts an exemplary color code that may be used to implement the invention.

FIG. 5 depicts two different color schemes used to control two animated objects sharing a control path.

FIG. 6 is a flow chart of a process that may be used to design the control path of the invention.

FIG. 7 is a flowchart of a process that may be used by the present invention to animate an object or objects along a control path.

FIG. 8 is an exemplary block diagram of a client apparatus that may be used to implement the present invention.

### DETAILED DESCRIPTION OF THE PREFERRED EMBODIMENT

According to the present invention, an image of a path is created. Then, the image is color-coded to define the behavior of an animated object along the path. An image is used because images are both easy to create and easy to process. That is, images can be created by any of a number of different applications programs. Some of these application programs include Microsoft Paint (a product of Microsoft Corp.) and Paint Shop Pro® (a product of Jasc Software, Inc.). Indeed, images may be created by most image editing software programs since they are all capable of generating straight lines, rounded arcs, and other more complex geometric shapes.

The images may be stored in files or created only in RAM. The only significant restriction on the images is that they be loss-less. A loss-less image is an image that is stored either uncompressed or by using a loss-less compression scheme, such as Zip compression. Images formats such as Microsoft's Bitmap (BMP) and Portable Network Graphics (PNG) format are typically loss-less. Lossy compression schemes, such as typically used in Graphics Interchange Format (GIF) and Joint Photographic Experts Group (JPEG) files may not be appropriate.

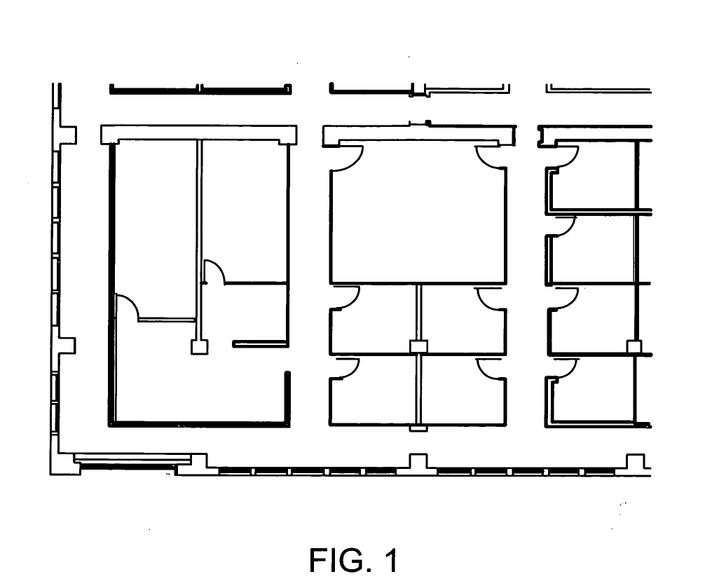

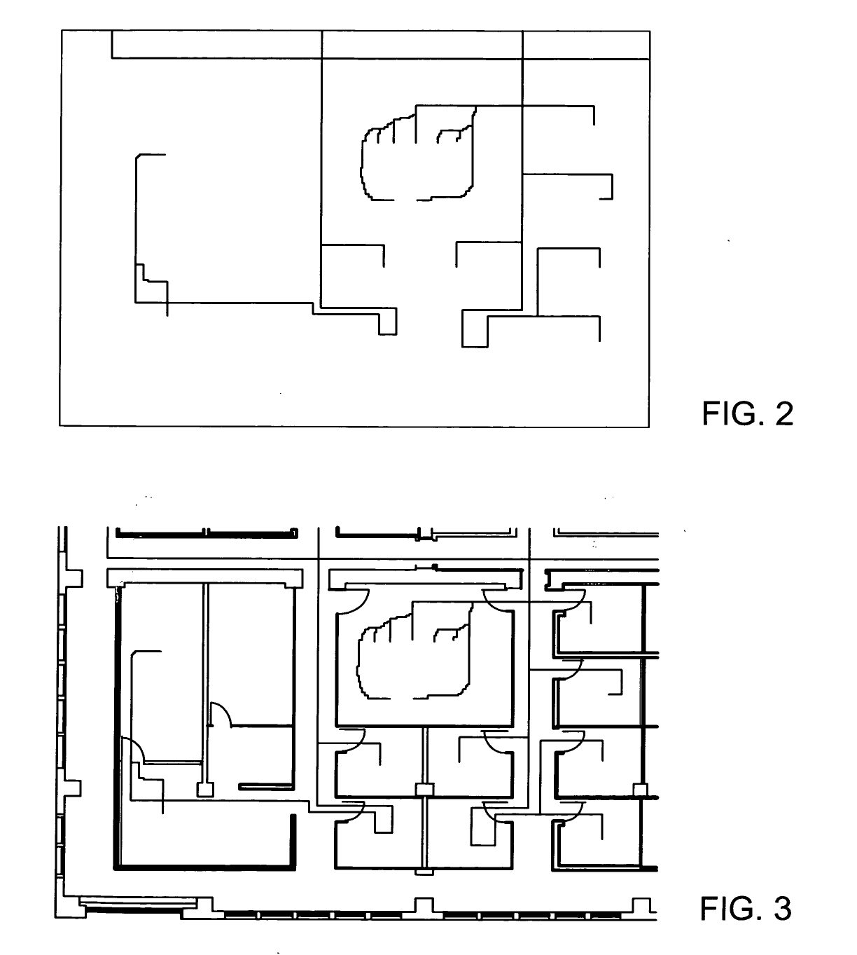

With reference now to the figures, FIG. 1 depicts a floor plan of a floor of a building. The floor plan may be used as a background figure to generate an evacuation path of the floor, for example. Thus, using FIG. 1 as a background image, an animator may draw the path depicted in FIG. 2. Thus, FIG. 2 depicts a path along which an animated object (e.g., a person) may travel to evacuate the floor of the building. FIG. 3 depicts FIG. 2 superimposed on FIG. 1.

In this particular example, the path is drawn in BLACK. Thus, BLACK may be used (as a default color) to instruct an animated object to continue in a current direction if that position shares the behavior (i.e., the same black color), otherwise to find an adjacent position that shares the behavior without backtracking. For example, if the animated object is moving from right-to-left and the control path along which the object is moving is BLACK, the object may continue to move in that direction following the path. If at a certain point in the control path (e.g., at an intersection) the animator desires that the animated object take a particular action (i.e., change direction) a different color may be used at that intersection. Particularly, the animator may define the animated object to move from right-to-left and if it encounters the color RED to turn right. Thus, a red dot, for example, may be placed at that intersection. Consequently, when the object is moving in the predetermined direction and encounters the red dot, it will change direction accordingly.

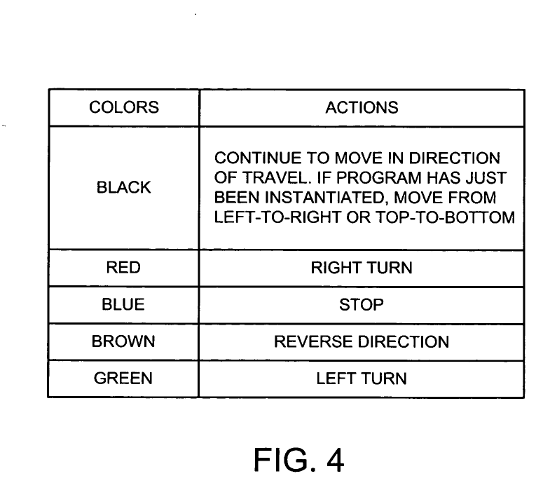

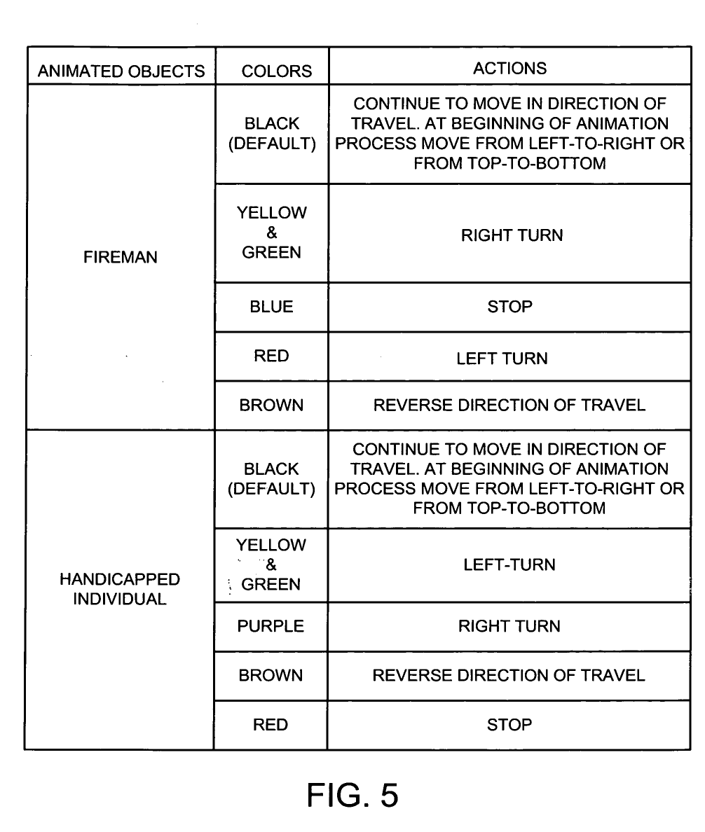

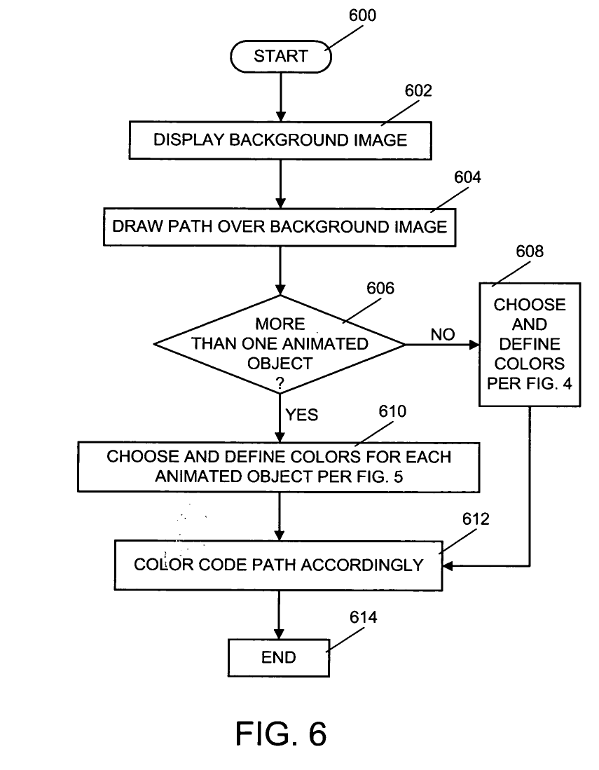

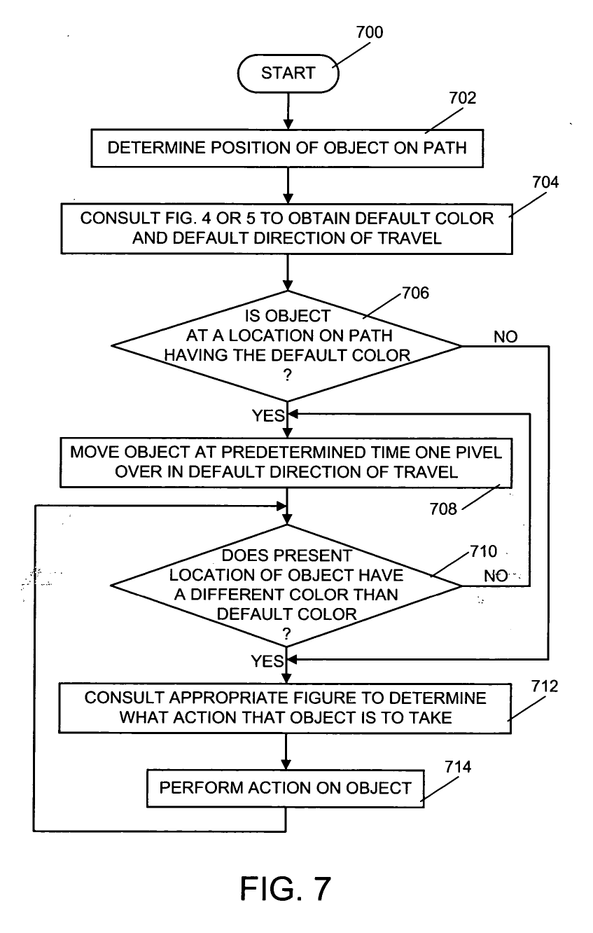

FIG. 4 depicts an exemplary color code that may be used to implement the invention. In the figure, BLACK is used as a default color and is there to instruct an animated object to continue its travel in whatever direction that it is traveling. In the case where the animation has just been instantiated, the animated object, based on its starting position on the path, may start to travel from left-to-right or top-to-bottom. This direction of travel will continue until a dot colored RED, GREEN, BLUE or BROWN is encountered. If a red dot is encountered, the object has to follow an adjacent black path that is closest to its right. If instead, the object encounters a GREEN dot, it has to follow an adjacent black path closest to its left. If it is a BLUE dot, then it has to stop moving. Depending on the implementation, the object may stop momentarily or definitively. A BROWN dot may instruct the object to reverse its direction of travel.

In some cases, more than one animated object may share a control path. In those cases, one color may have a different significance for each one of the objects or may have significance to one animated object while it has no significance to another animated object etc. For example, suppose two animated objects (e.g., a fireman and a handicapped individual) are to use the evacuation path of FIG. 2, the fireman may be directed toward a flight of stairs while the handicapped individual may be directed toward a ramp. Thus, if the two animated objects start at the same point on the path, they will have to be directed toward a different finishing point. Thus in such cases, a different color scheme may have to be used with each animated object.

FIG. 5 depicts two different color schemes used to control two animated objects sharing a control path. Each color scheme is shown to be associated with an animated object. For example, the animated object representing a fireman will turn right when it encounters either a YELLOW or GREEN dot whereas an animated object representing a handicapped individual will turn left when it encounters a YELLOW or BLUE dot. Note that YELLOW is used since a BLUE dot and a GREEN dot placed at the same location will produce a YELLOW dot. In accordance with the invention, any combination of colors may be thus used to control the animated objects.

Returning to the figure, a fireman will ignore a purple dot while a handicapped individual will ignore a GREEN dot. A RED dot instructs each one of the animated objects to take a different action (i.e., a fireman will turn left and a handicapped individual will stop). Likewise, a BLUE dot provides two different instructions, one to a handicapped individual and another to a fireman. A BROWN dot, on the other hand, provides the same instruction to both a fireman and a handicapped individual (e.g., reverse direction).

After the animator has placed the colored dots at the proper locations on the control path, a program may (but not necessarily) be used to convert the dots into action codes. In FIG. 4 for example, a dot colored RED, BLUE, BROWN or GREEN may be converted into code that will instruct an animated object to turn right, stop, reverse direction or turn left, respectively, when the animated object is at the X-Y coordinates (on the screen) where the dot was placed. In such a case, therefore, the invention obviates the need for an animator to painstakingly determine actual X-Y coordinates where action codes are to be placed.

If the application program with which the animator draws the path of FIG. 2 allows different images to be combined together into a file, then FIG. 3 may be stored in one file. Otherwise, two files may be used, one to store the background image (i.e., FIG. 1) and the other to store the image of the path (i.e., FIG. 2).

Note that only specific points of significance along the path may be stored. In other words, the white background of FIG. 2 or the gray and white background of FIG. 1 may be discarded. Doing so may greatly reduce the size of the file and thereby reducing the time it requires to load the file in system memory as well as the amount of system memory needed to execute the animation program. Doing so may greatly enhance the performance of the system, especially in cases where a large path image is used.

Note further that although the invention has been described using colored dots, it is not thus restricted. For example, grayscale values may be used instead of colored dots. Thus, colored dots are used for illustrative purposes only. In addition, note that FIG. 5 may contain as many color schemes as there are objects to animate. In such a case, each color scheme may be associated with a specific object.

FIG. 6 is a flow chart of a process that may be used to design the control path of the invention. The process starts when the animator decides to implement the invention (step 600). At that point the animator may display the background image (i.e., FIG. 1) on a computer screen. After displaying the background image, the animator may, using an image editor, draw the path (i.e., FIG. 2) over the background image (steps 602 and 604). If two or more animated objects are to use the path, the animator needs to choose and define colors to be used with each one of the animated objects as shown in FIG. 5. If instead, only one animated object is to use the path, then the animator only needs to choose and define the colors as shown in FIG. 4. Note that an animated object may be one animated object or a set of animated objects so long as they are to behave similarly along the path. After the colors have been chosen and defined, the animator may color code the path to properly control the animated object or objects. Once this is done, the process may end (steps 606-614).

FIG. 7 is a flowchart of a process that may be used by the present invention to animate an object or objects. The process starts when the object or objects are to be animated (step 700). Then the position of the object or objects on the path is determined. If one object is being animated FIG. 4 is consulted to obtain the default color as well as the default direction of travel. If instead more than one object is being animated, FIG. 5 may be consulted to obtain the requisite information (steps 702, 704). A check may then be performed to determine whether or not the location of the object on the path is of the default color. Note that this check will be performed for each object, when more than one object is being animated. If so, the object or objects will be moved by one or more pixels, depending on the implementation, at a pre-determined time (steps 706 and 708).

After the object or objects have been moved, another check will be done to determine whether the present location of the object or objects is of the default color. If so, the process will jump back to step 708. If this is not true for an object, the appropriate figure (i.e., FIG. 4 for one object or FIG. 5 for more than one object) will be consulted to determine what action to perform on the object for which the outcome of test was not true (step 712). After obtaining the information, the appropriate action may be performed on the object and the process may jump back to step 710 (step 714). The process may end when the animated object has reached its destination.

Thus, the present invention provides a simplified method of path generation for 2D animations. The method allows an animator to visualize the animation as control paths are being created. The advantages of the invention include:
(1) Ease of Use: Most image editors have a number of ways to generate straight lines, rounded arcs, and other shapes. This allows an animator to generate some paths by hand quickly while reducing error. For some behaviors, this can be very useful.
(2) Reference Images: When the animation is moving relative to a background image (e.g., FIG. 1), we may wish to move objects within the confines of items in that image, such as keeping objects within the confines of hallways. Many image editors allow a semi-transparent layer to be used to generate a control image (e.g., FIG. 2) over the background image. An animator may then easily create the control paths to match the background image, since both images are lined up while the control image is being generated.
(3) Additive Painting: By blending colors, an animator is able to encode multiple behaviors at a position. For example, using RGB colors an animator may use red (0×FF0000) to represent the path to follow for one object and green (0×00FF00) to encode the path that another object is to follow. Using additive painting, a point at which the paths intersect may be yellow (0×FFFF00). Thus, when using a 32-bit color model, for example, 32 different behaviors can be easily extracted from a given position. Consequently, although only one simple behavior is described, the number of behaviors that may be encoded is limited only by the number of bits assigned to each color in the image format.

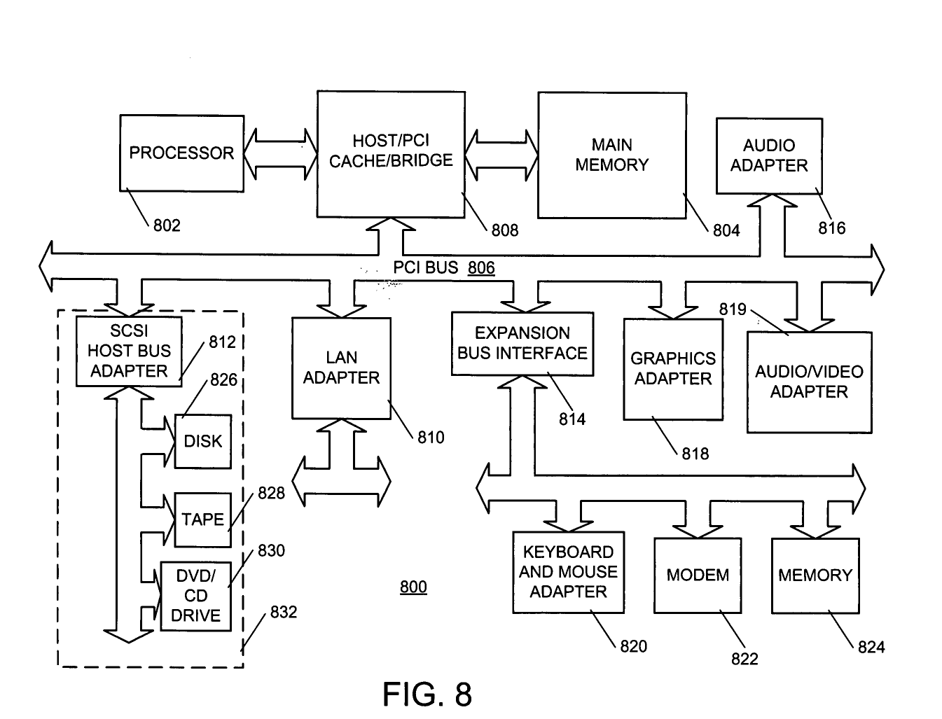

With reference now to FIG. 8, a block diagram illustrating a data processing system is depicted in which the present invention may be implemented. Data processing system 800 employs a peripheral component interconnect (PCI) local bus architecture. Although the depicted example employs a PCI bus, other bus architectures such as Accelerated Graphics Port (AGP) and Industry Standard Architecture (ISA) may be used. Processor 802 and main memory 804 are connected to PCI local bus 806 through PCI bridge 808. PCI bridge 808 also may include an integrated memory controller and cache memory for processor 802. Additional connections to PCI local bus 806 may be made through direct component interconnection or through add-in boards. In the depicted example, local area network (LAN) adapter 810, SCSI host bus adapter 812, and expansion bus interface 814 are connected to PCI local bus 806 by direct component connection. In contrast, audio adapter 816, graphics adapter 818, and audio/video adapter 819 are connected to PCI local bus 806 by add-in boards inserted into expansion slots. Expansion bus interface 814 provides a connection for a keyboard and mouse adapter 820, modem 822, and additional memory 824. Small computer system interface (SCSI) host bus adapter 812 provides a connection for hard disk drive 826, tape drive 828, and CD-ROM/DVD drive 830. Typical PCI local bus implementations will support three or four PCI expansion slots or add-in connectors.

An operating system runs on processor 802 and is used to coordinate and provide control of various components within data processing system 800 in FIG. 8. The operating system may be a commercially available operating system, such as Windows XP, which is available from Microsoft Corporation. An object oriented programming system such as Java may run in conjunction with the operating system and provide calls to the operating system from Java programs or applications executing on data processing system 800. “Java” is a trademark of Sun Microsystems, Inc. Instructions for the operating system, the object-oriented operating system, and applications or programs are located on storage devices, such as hard disk drive 826, and may be loaded into main memory 804 for execution by processor 802.

Those of ordinary skill in the art will appreciate that the hardware in FIG. 8 may vary depending on the implementation. Other internal hardware or peripheral devices, such as flash ROM (or equivalent nonvolatile memory) or optical disk drives and the like, may be used in addition to or in place of the hardware depicted in FIG. 8. Also, the processes of the present invention may be applied to a multiprocessor data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of creating a control path for an animated object comprising the steps of:
drawing a control path over a background image, the background image being an image through which the animated object is to navigate; and
assigning colors at different locations of the control path, the colors for instructing the animated object to take specific actions along the control path.

2. The method of claim 1 wherein the control path is assigned a default color, the default color for instructing the animated object to continue in a direction of travel.

3. The method of claim 2 wherein the default color indicates a default direction of travel.

4. The method of claim 3 wherein the control path is used to control a plurality of animated objects, each animated object being associated with a color scheme, each color scheme for instructing the animated object with which associated to take specific actions along the control path.

5. The method of claim 4 wherein each control path is stored as an image file.

6. A computer program product on a computer readable medium for creating a control path for an animated object comprising:
code means for drawing a control path over a background image, the background image being an image through which the animated object is to navigate; and
code means for assigning colors at different locations of the control path, the colors for instructing the animated object to take specific actions along the control path.

7. The computer program product of claim 6 wherein the control path is assigned a default color, the default color for instructing the animated object to continue in a direction of travel.

8. The computer program product of claim 7 wherein the default color indicates a default direction of travel.

9. The computer program product of claim 8 wherein the control path is used to control a plurality of animated objects, each animated object being associated with a color scheme, each color scheme for instructing the animated object with which associated to take specific actions along the control path.

10. The computer program product of claim 9 wherein each control path is stored as an image file.

11. An apparatus for creating a control path for an animated object comprising:
means for drawing a control path over a background image, the background image being an image through which the animated object is to navigate; and
means for assigning colors at different locations of the control path, the colors for instructing the animated object to take specific actions along the control path.

12. The apparatus of claim 11 wherein the control path is assigned a default color, the default color for instructing the animated object to continue in a direction of travel.

13. The apparatus of claim 12 wherein the default color indicates a default direction of travel.

14. The apparatus of claim 13 wherein the control path is used to control a plurality of animated objects, each animated object being associated with a color scheme, each color scheme for instructing the animated object with which associated to take specific actions along the control path.

15. The apparatus of claim 14 wherein each control path is stored as an image file.

16. A system for creating a control path for an animated object comprising:
at least one storage system for storing code data; and
at least one processor for processing the code data to draw a control path over a background image, the background image being an image through which the animated object is to navigate, and to assign colors at different locations of the control path, the colors for instructing the animated object to take specific actions along the control path.

17. The system of claim 16 wherein the control path is assigned a default color, the default color for instructing the animated object to continue in a direction of travel.

18. The system of claim 17 wherein the default color indicates a default direction of travel.

19. The system of claim 18 wherein the control path is used to control a plurality of animated objects, each animated object being associated with a color scheme, each color scheme for instructing the animated object with which associated to take specific actions along the control path.

20. The system of claim 19 wherein each control path is stored as an image file.
